(19) United States
(12) Patent Application Publication
(10) Pub. No.: US 2008/0022399 A1
(43) Pub. Date: Jan. 24, 2008

(54) Information processing apparatus, information processing method, and computer program product

(75) Inventor: Tomohide Takano, Chiba (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 11/826,902

(22) Filed: Jul. 19, 2007

(30) Foreign Application Priority Data
Jul. 21, 2006 (JP) 2006-199692

(51) Int. Cl. H04L 9/32

(52) U.S. Cl. 726/21

(57) ABSTRACT

An information processing apparatus includes a first receiving unit that receives a desired application program, condition data for using the desired application program, and user data. An authority-data generating unit generates authority data from the received data. A recording unit records the authority data on a portable recording medium. When a second receiving unit receives, from outside, a request for a predetermined process that is generated based on the desired application program, a processing unit performs the predetermined process.

### CROSS-REFERENCE TO RELATED APPLICATIONS

The present application claims priority to and incorporates by reference the entire contents of Japanese priority document, 2006-199692 filed in Japan on Jul. 21, 2006.

### BACKGROUND OF THE INVENTION

1. Field of the Invention

The present invention relates to a technology for managing authentication information.

2. Description of the Related Art

A technology for providing various functions available only for an authorized user has been disclosed in recent years. The authorized user is given authentication information that is required for operating a target information processing apparatus having a desired function such as an image forming apparatus, a multifunction product (MFP), a server, and various embedded devices. The authorized user operates the target information processing apparatus from a distant place via a user computer such as a personal computer. With this technology, the authorized user can check setting parameters of the target information processing apparatus via a web page. If the target information processing apparatus is an MFP, the authorized user can print out data by using a printing function, or input an image by using a network scanner function.

In those information processing apparatuses, user authentication through a user input, such as a password, is conventionally performed to identify the user or restrict available functions.

Also, to reduce the load on the user, an authentication device is often used, such as an integrated circuit (IC) card reader, a radiofrequency identification (RFID) reader, or a biometrics (device that checks a fingerprint, vein, or iris in the eye), to achieve a good balance between usability and security.

IC cards have become widely used as employee identification cards or student identification cards. Access to personal authentication information that is recorded on an IC card is usually restricted by security functions provided with the IC card to avoid the risk of information leakage. How to access to the authentication information is secret.

When a device, such as an image forming apparatus, is newly introduced, there is a demand for establishing a personal authentication system by using employee identification cards or student identification cards already in operation. To meet such a demand, when the scheme of accessing personal authentication information in an IC card is disclosed, a control program in the image forming apparatus is customized based on, for example, the information about the disclosed accessing scheme.

In digital rights management (DRM), an electronic ticket has been widely used.

Japanese Patent Application Laid-Open No. 2005-509231 discloses a technology for managing a stored-value data object such as an electronic ticket, more particularly, a device for reliably managing a wireless transaction process with a stored-value data object. A wireless device requests a ticket issuing system to issue a necessary stored-value data object. The ticket issuing system then encrypts the requested stored-value data object by using a public key received from the wireless device, thereby securely transmitting information to the wireless device.

However, if the authentication information given to the user is protected by a password or an ID, the user has to manage the password or the ID. The higher the security become, the better the user is required an ability to manage, thereby decreasing usability. For example, if a security policy is applied, such as “authentication information is formed of a password with sixteen characters or more, and do not take notes about the password”, it is impossible to remember such sixteen or more characters. Many users may take notes a sheet about the password, and the sheet may be lost or a third party may have a peep at the sheet. This causes a security hole that allows unauthorized access.

Moreover, even in the case of using an authentication scheme by an authentication device such as an IC card reader, compared with the case of an information processing apparatus such as any of various embedded devices, it is difficult to set an expensive reader/writer for physical authentication in every PC owned individually.

### SUMMARY OF THE INVENTION

It is an object of the present invention to at least partially solve the problems in the conventional technology.

According to an aspect of the present invention, there is provided an information processing apparatus that includes a storage unit that stores therein at least one application program that is used for generating a request for a predetermined process to a target device having a corresponding function; a first receiving unit that receives various information including a desired application program among the application programs, condition data for using the desired application program, and user data that is information about an authentic user; an authority-data generating unit that generates authority data including the desired application program, the condition data, and the user data, in a corresponding manner; a recording unit that records the authority data on a portable recording medium; a second receiving unit that receives, from outside, a request for the predetermined process that is generated based on the desired application program contained in the authority data recorded on the recording unit; and a processing unit that performs the predetermined process in response to received request.

According to another aspect of the present invention, there is provided a method of processing information that includes receiving an instruction of specifying a desired application program that is selected among application programs stored in a storage unit that are used for generating a request for a predetermined process to a target device having a corresponding function; receiving an instruction of setting conditions for using the desired application program; receiving user data that is information about an authentic user; generating an authority data that includes the desired application program, data for the conditions, and the user data in a corresponding manner; an authority-data generating unit that generates authority data including the desired application program, the condition data, and the user data, in a corresponding manner; recording the authority data on a portable recording medium; receiving, from outside, a request for the predetermined process that is generated based on the desired application program contained in the authority data recorded on the recording unit; and processing the predetermined process in response to received request.

According to still another aspect of the present invention, there is provided a computer program product that causes a computer to implement the above method.

According to still another aspect of the present invention, there is provided a method of processing information that includes receiving authority data including a desired application program that is used for generating a request for a predetermined process to a target device having a corresponding function, condition data for using the desired application program, and user data that is information about an authentic user, in a corresponding manner; determining based on the condition data whether the desired application program is to be executed; and executing, when the desired application program is determined to be executed at the determining, the desired application program whereby the request for the predetermined process is sent to the target device.

According to still another aspect of the present invention, there is provided a computer program product that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image forming apparatus according to an embodiment of the present invention;

FIG. 2 is a block diagram of a hardware configuration of the image forming apparatus shown in FIG. 1;

FIG. 3 is a functional block diagram a scanned-data processing unit 50 of the image forming apparatus shown in FIG. 1;

FIG. 4 is a schematic diagram of a data structure of authentication information and condition data for usage of an application program shown in FIG. 3;

FIG. 5 is a schematic diagram of a display screen displayed on an operation panel for obtaining authentication information from an IC card;

FIG. 6 is a schematic diagram of a display screen for security settings that is displayed when a password setting button shown in FIG. 5 is pressed;

FIG. 7 is a schematic diagram of a display screen for security settings that is displayed when a serial setting button shown in FIG. 5 is pressed;

FIG. 8 is a schematic diagram of a display screen for security settings that is displayed when a maximum-count setting button shown in FIG. 5 is pressed;

FIG. 9 is a schematic diagram of a display screen for security settings that is displayed when an expiration-date setting button shown in FIG. 5 is pressed;

FIG. 10 is a schematic diagram of a display screen for security settings that is displayed when a button of activation shown in FIG. 5 is pressed;

FIG. 11 is a flowchart of a process performed by the image forming apparatus shown in FIG. 1 to store a ticket in a portable storage medium;

FIG. 12A is a flowchart of a process to execute an application program stored in an USB memory by the image forming apparatus; and

FIG. 12B is a continuation of the flowchart shown in FIG. 12A.

### DETAILED DESCRIPTION OF THE PREFERRED EMBODIMENTS

Exemplary embodiments of the present invention are described in detail below with reference to the accompanying drawings. As one of examples, an image forming apparatus having various functions, such as printer, facsimile, and copier is used for the information processing apparatus, and a contactless integrated circuit (IC) card reader/writer is used for a device for reading authentication information.

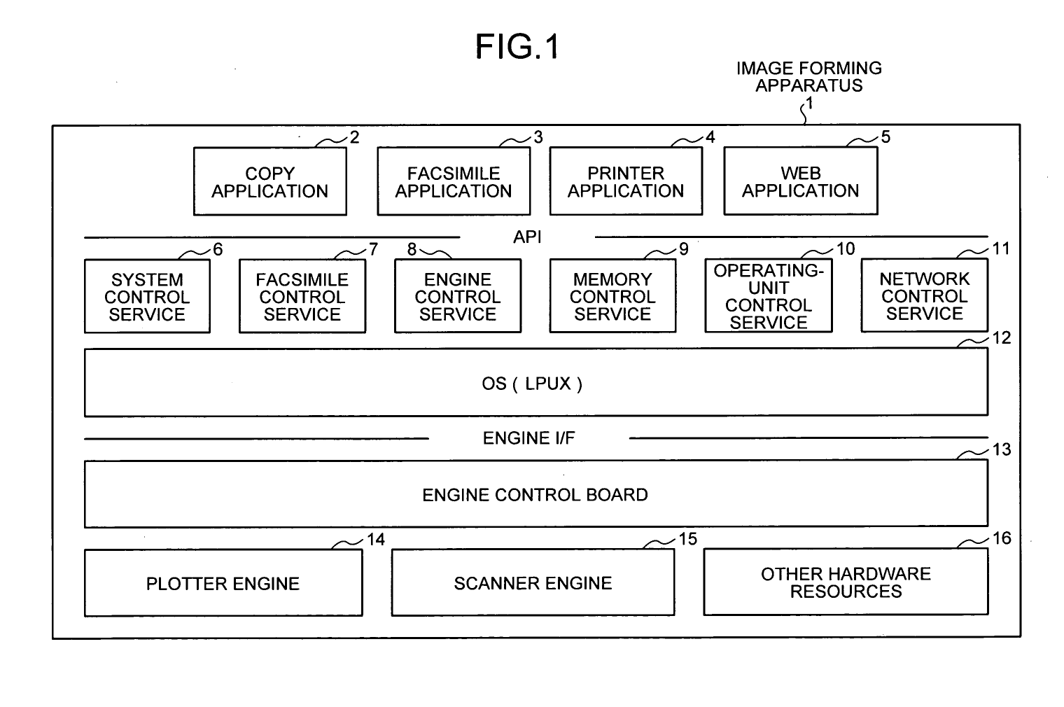

FIG. 1 is a functional block diagram of an image forming apparatus 1 according to an embodiment of the present embodiment. The image forming apparatus 1 includes a copy application 2, a facsimile application 3, a printer application 4, a web application 5, a system control service 6, a facsimile control service 7, an engine control service 8, a memory control service 9, an operating-unit control service 10, a network control service 11, an operating system (OS) 12, an engine control board 13, a plotter engine 14, a scanner engine 15, and other hardware resources 16. The copy application 2, the facsimile application 3, the printer application 4, and the web application 5 are provided for users.

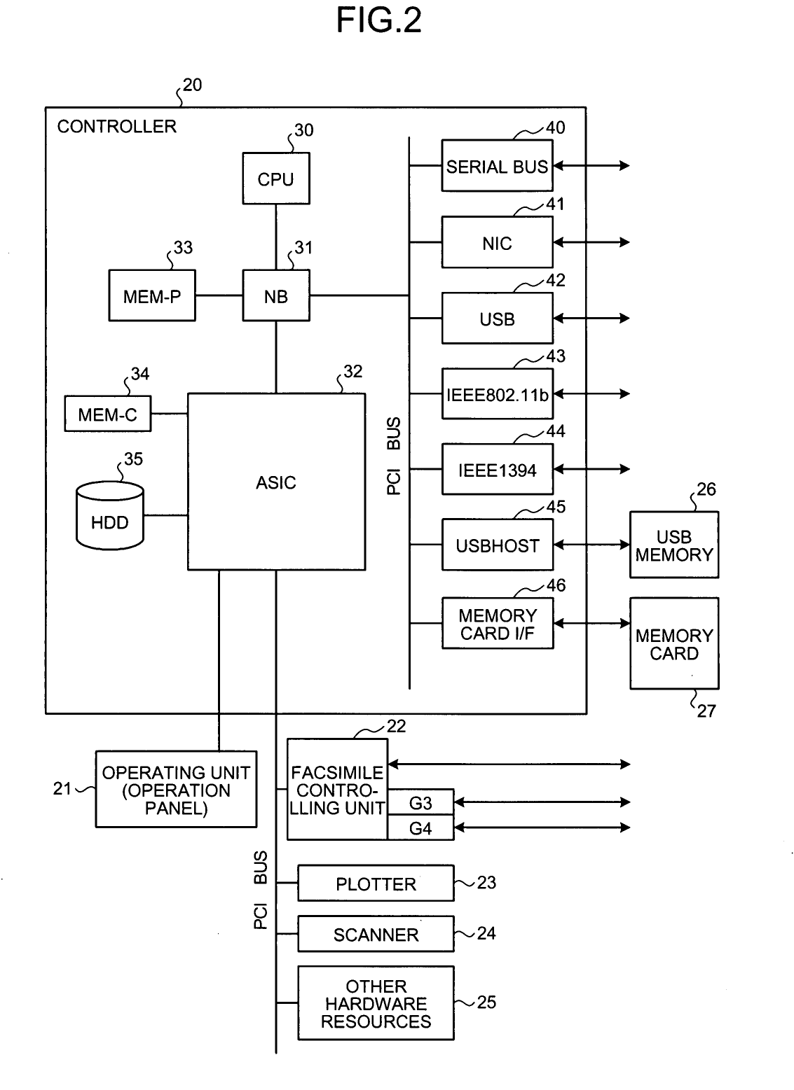

FIG. 2 is a block diagram of a hardware configuration of the image forming apparatus 1. The image forming apparatus 1 includes a controller 20, an operating unit (operation panel) 21, a facsimile controlling unit 22, a plotter 23, a scanner 24, other hardware resources 25, a universal serial bus (USB) memory 26, and a memory card 27. The controller 20 includes a central processing unit (CPU) 30, a north bridge (NB) 31, an application specified integrated circuit (ASIC) 32, a memory-P 33, a memory-C 34, a hard disk drive (HDD) 35, a serial bus 40, a network interface card (NIC) 41, a USB 42, an institute of electrical and electronics engineers (IEEE) 802.11b 43, IEEE 1394 44, a USB host 45, and a memory card I/F 46.

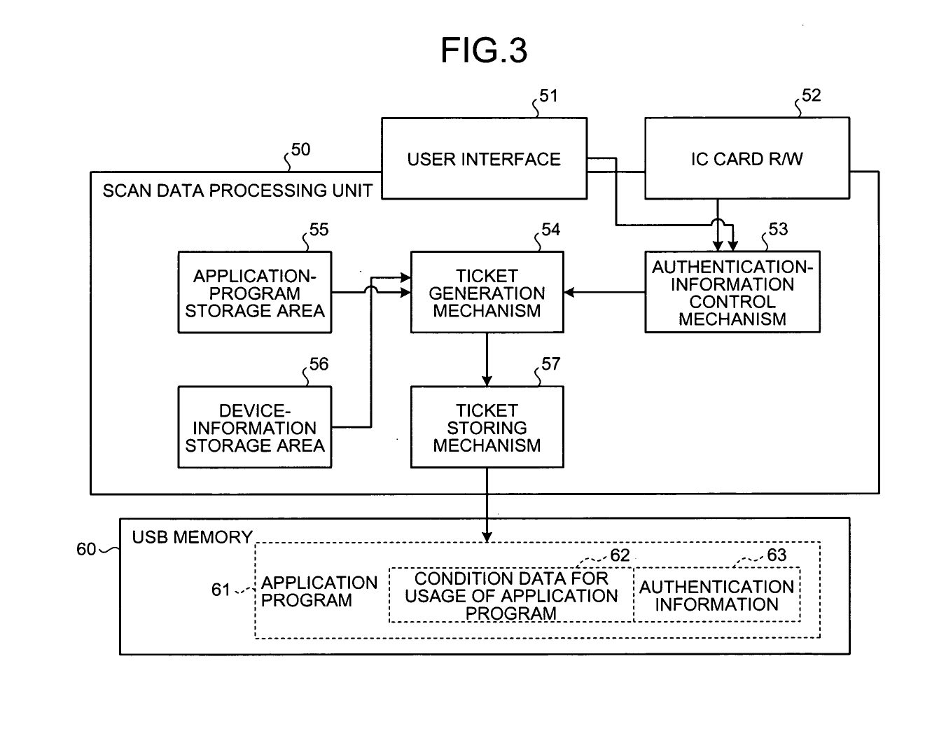

FIG. 3 is a functional block diagram of a scanned-data processing unit 50 of the image forming apparatus 1 that performs a salient process. The scanned-data processing unit 50 includes a user interface 51, an IC card read/write (R/W) 52, an authentication-information control mechanism 53, a ticket generation mechanism 54, an application-program storage area 55, a device-information storage area 56, and a ticket storing mechanism 57.

The authentication-information control mechanism 53, in response to instructions received from the user interface 51, causes the IC card R/W 52 to read authentication information from an IC card and obtains the authentication information from the IC card R/W 52. An authentication process based on the obtained authentication information can be performed by either an external authentication server (not shown) or an inner unit (not shown). In the authentication process, restriction of available functions or management of bill information can be performed in addition to user identification.

The application-program storage area 55 stores therein various application programs. The application programs enable a computer to access and cause a target device to execute various functions. The application programs are, for example, applications and scripts that can be directly run on a computer or plug-ins of applications that has been installed on the PC, more particularly, programs for causing a computer to perform various settings, printing, facsimile transmission, and scanner reading. A request that is issued based on those application programs is transmitted with authentication information provided thereto. A device to be accessed by the computer will be explained later.

The device-information storage area 56 stores therein device information of a device to be accessed by the application program. The device information includes, for example, a media access control (MAC) address, a network address, a serial number, and a model name of the device.

The ticket generation mechanism 54 extracts a predetermined application program from the application programs stored in the application-program storage area 55. The ticket generation mechanism 54 generates a ticket that includes the extracted application program, the authentication information obtained by the authentication-information control mechanism 53, and the device information stored in the device-information storage area 56. That is, the ticket includes the application program that contains condition data for usage of the application program, and the authentication information.

The application program and device information are selected based on an instruction from the user. The ticket storing mechanism 57 stores the ticket generated by the ticket generation mechanism 54 in a USB memory 60 (portable storage medium).

The USB memory 60 is an example of a portable storage medium. Any portable writable or write-once medium can be used other than the USB memory 60, such as a semiconductor medium (for example, a non-volatile memory, such as compact flash® or SD cards), an optical medium (for example, a digital versatile disk-recordable (DVD-R), a magneto-optical (MO) medium, or a compact disk-recordable (CD-R)), and a magnetic medium (for example, a magnetic tape or a flexible disk).

The USB memory 60 storing therein a ticket that contains the application program and the device information is connected to a user terminal. At the user terminal, the application program stored in the USB memory 60 is executed, thereby sending a request for performing a desired process based on a specific function to any device having the specific function such as the image forming apparatus 1, another image forming apparatus, or a device other than any image forming apparatuses. To which device the request is sent is determined by serial settings, which will be explained later. The device that receives the request (hereinafter, “target device” and the user terminal are connected to each other via, for example, a network. It is allowable that the target device can communicate with the user terminal via a bus by using a USB or Centronics.

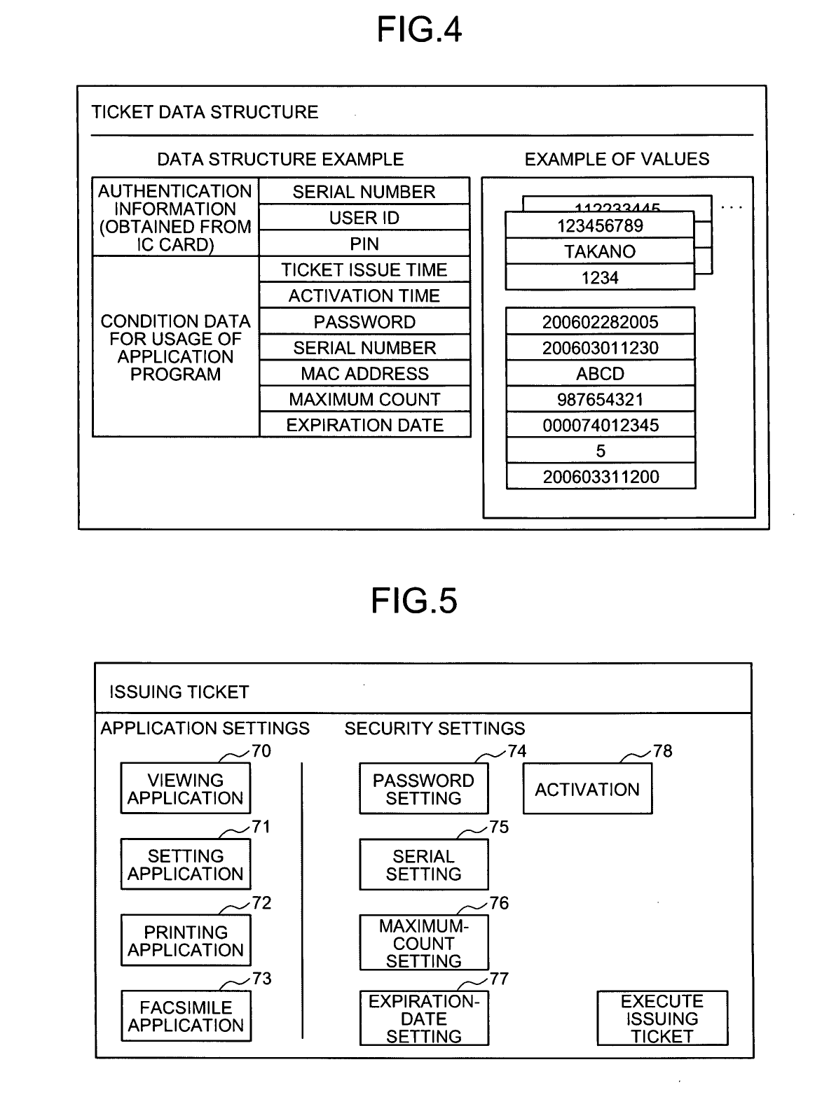

FIG. 4 is a schematic diagram of a data structure of the authentication information and the condition data for usage of the application program contained in the application program shown in FIG. 3. The authentication information in the data structure is obtained from the IC card. The IC card can store therein a plurality of pieces of authentication information. Even if necessary authentication information differs depending on a function, the IC card collectively stores therein various information required for a plurality of available functions. Moreover, the IC card can collectively store therein various condition data.

Display screens displayed on the operation panel 21 during a ticket generating process are explained below with reference to FIGS. 5 to 10. Instructions made by the user via the display screens are sent to the authentication-information control mechanism 53 via the user interface 51.

FIG. 5 is a schematic diagram of a display screen displayed on the operation panel 21 for obtaining authentication information from an IC card. This display screen is displayed after the user specifies the USB memory 60 as a storage unit for the authentication information. On this screen, the user selects a desired application program to be stored in the USB memory 60 considering a corresponding function of the application program, and sets security data appropriately. To improve usability, the operation panel 21 is preferably a touch panel.

As shown in FIG. 5, the user can select any one or more of a viewing application 70, a setting application 71, a printing application 72, and a facsimile application 73 as desired application programs. The application programs displayed on the display screen are stored in the application-program storage area 55.

Each application program corresponds to a function provided by the image forming apparatus. The viewing application 70 corresponds to a function of viewing, from the user computer, information such as a remaining tone amount, a stacked sheet amount, error state, and other setting information of the image forming apparatus. The setting application 71 corresponds to a function of setting, from the user-computer, parameters such as resolution and scaling-up or scaling-down settings. The printing application 72 corresponds to a printing function of the image forming apparatus. The facsimile application 73 corresponds to a function of facsimile transmission from the image forming apparatus. These application programs automatically attach the authentication information to a request and the request causes the target device to execute a corresponding function. In consideration of usability, the viewing application 70 is preferably selected together with another application program.

Also, security setting items includes a password setting 74, a serial setting 75, a maximum count setting 76, and an expiration-date setting 77, and an activation setting 78. By using these settings, the condition data is included in a ticket. The password setting 74 sets a password to be inquired of a user when the application program starts to run on the user computer. The serial setting 75 sets data to be used when the target device that receives a request generated based on the application program determines whether a function such as viewing, setting, printing, or facsimile is to be performed.

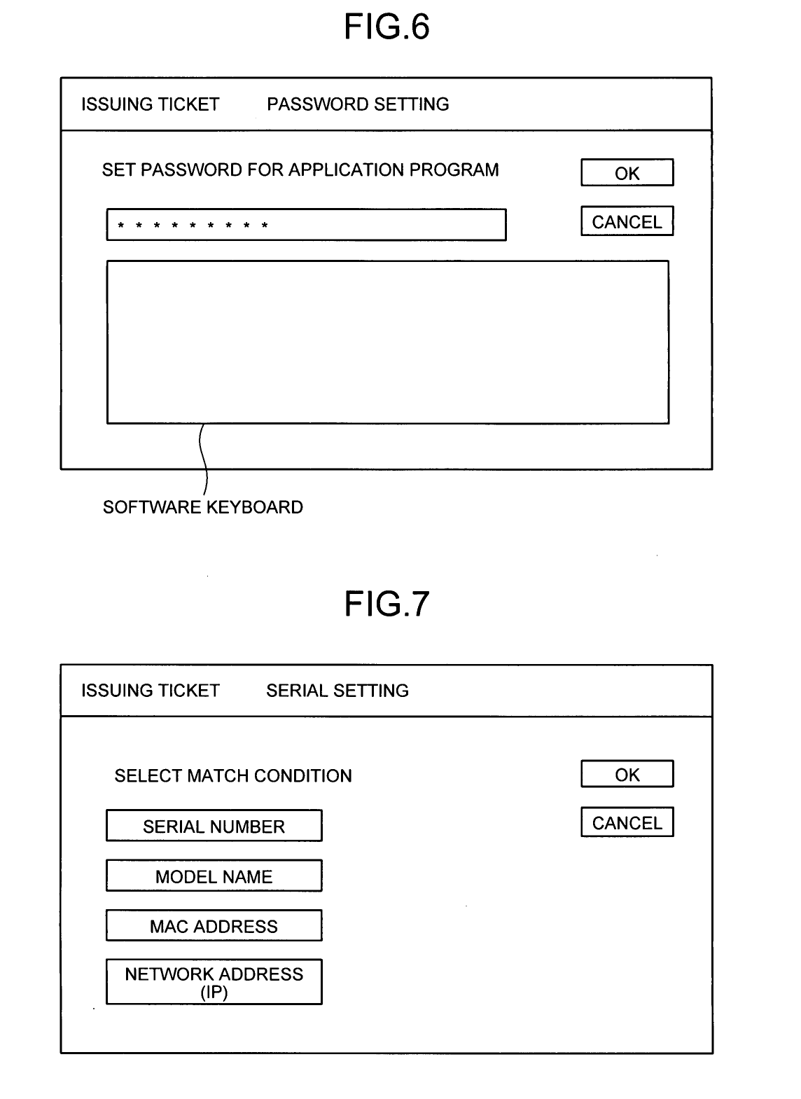

FIG. 6 is a schematic diagram of a display screen displayed when a button for the password setting 74 is pressed. When a password is set, the password is contained in the application program, and when the application program stored in the USB memory 60 is executed on the PC, the user is inquired of the password. Thereby, even if the USB memory that stores therein the application program is lost, the possibility that an unauthorized user uses the application program can be significantly reduced.

FIG. 7 is a schematic diagram of a display screen displayed when a button for the serial setting 75 is pressed. That is, the application program can use a function of only the target device matching with a condition of the serial setting 75. That is, by containing data for specifying the target device in the application program, no devices other than the target device specified by the condition can perform the function such as printing or facsimile.

Moreover, if data common to a plurality of devices, for example, devices within a specific working place is set, an area accessible to the function can be limited. With the serial setting, a range where the authentication information can be used can also be restricted. For example, if data common to target devices within a working place is specified, it is possible to restrict a range where the authentication information is operable to the working place. That is, by containing the authentication information and the serial data as a condition, the ticket can restrict an area to be used. Thereby, even if a malicious third party brings out the authentication information contained in the ticket, the possibility of unauthorized use can be significantly reduced.

The items in the serial setting include device-mode information that belongs to the device, such as a serial number unique to the device, model name, MAC address, or network address. For the MAC address, perfect matching can be used for identifying a specific device, or the code indicative of a manufacturer can be used for identifying a group of devices made of an identical manufacture. A typical network address is an internet protocol (IP) address. If an IP network is set as the condition data, the application program can use a function of a target device having the IP network. It is possible to specify a group of target devices connecting to a specific network by using a sub-net mask. If a network address such as IP address is used as the condition data, the application program can be configured to be accessible to the network without network settings.

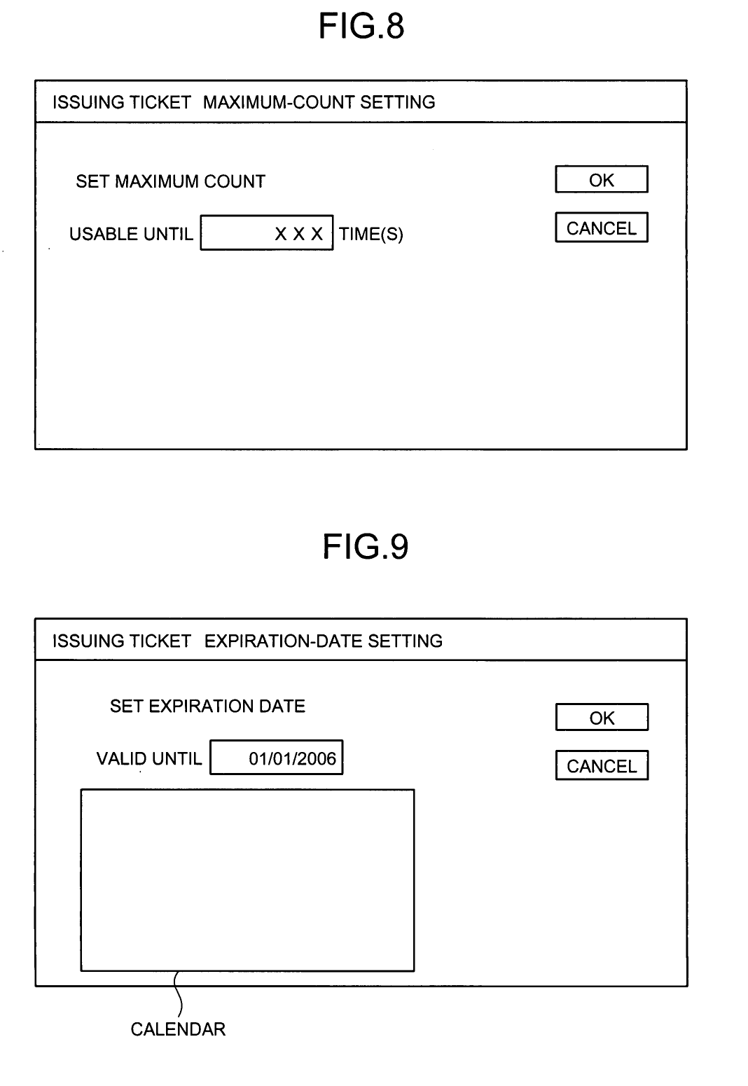

FIG. 8 is a drawing of a display screen displayed when a button for the maximum count setting 76 is pressed. In this display screen, there can set an upper limit of number of processing times based on the application program. When a maximum count is set, this maximum count is contained in the application program. If the authentication information is used over the maximum count, the authentication information contained in the application program is deleted.

FIG. 9 is a schematic diagram of a display screen displayed when a button for the expiration-date setting 77 is pressed. In this display screen, there can set an expiration date for the authentication information that is used for the application program. When an expiration date is set, the expiration date is contained in the application program. If the authentication information is used over the expiration date, the authentication information contained in the application program is deleted.

In the example shown in FIG. 9, the expiration date can be set with reference to a calendar format. The format is not necessarily a calendar format, and can be another format in which an elapsed time since a ticket issuing date is set.

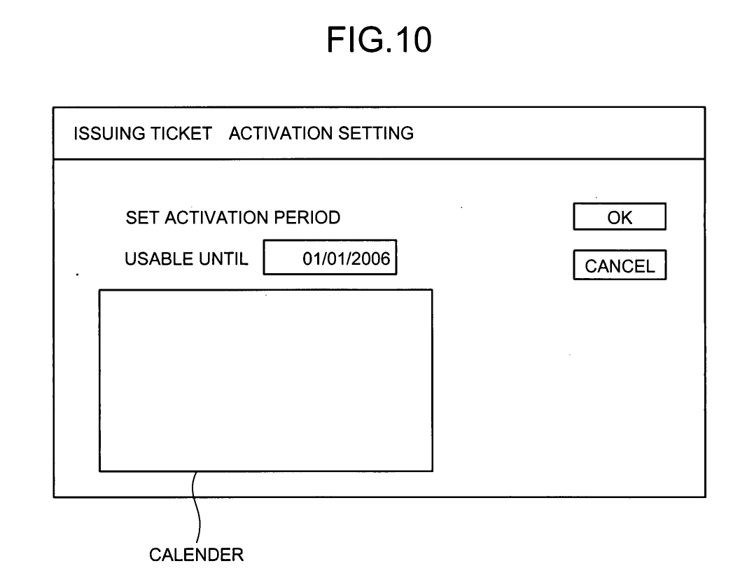

FIG. 10 is a schematic diagram of a display screen for security settings that is displayed when a button of the activation setting 78 is pressed. In this display screen, an activation period within which a first process is to be performed can be set. When an activation period is set, this activation period is contained in the application program. If the application program is first executed over the activation period, the authentication information contained in the application program is deleted.

With such an arrangement for security settings, when the ticket data is stored in a USB memory of a guest and then a laptop computer of the guest is used for sending a request for printing to the target device, security is ensured because the authentication information is automatically deleted after the maximum number of times or over expiration date. Even if there is only one IC card for guests, it is possible to deal with requests from a plurality of guests by issuing a plurality of tickets and storing each ticket to a USB memory.

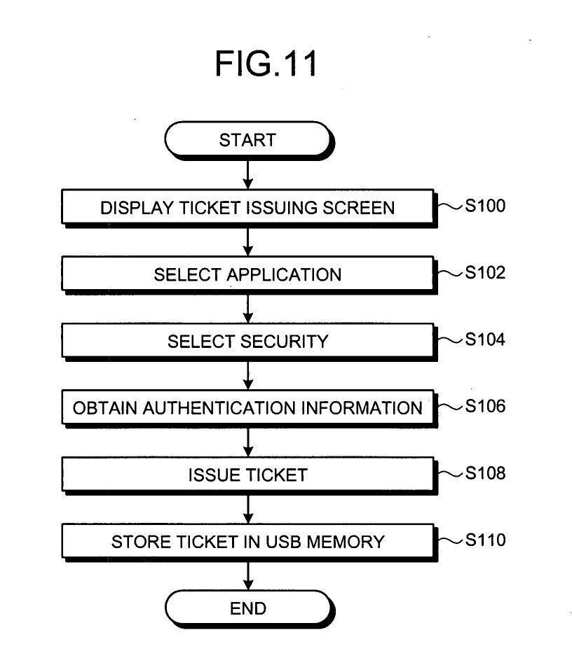

FIG. 11 is a flowchart of a process performed by the image forming apparatus 1 to store a ticket in a portable storage medium. When a ticket is stored in a portable storage medium, the display screen shown in FIG. 5 appears first (step S100). The portable storage medium to which a ticket is to be stored has preferably been connected to the image forming apparatus 1. The desired application program to be contained in the authentication information is specified (step S102). A plurality of application programs can be selected as the desired application programs. By defining available functions and storing data for the available functions in the IC card, the desired application programs can be selected from only programs corresponding to the available functions.

Thereafter, security data is set (step S104). A plurality of items for security settings can be set. Application selection and security selection are performed not in particular order, either of which can be selected first.

Authentication information is obtained (step S106). Specifically, an instruction for obtaining authentication information is issued, thereby obtaining the authentication information from the IC card. The authentication information is included in the application, that is, a ticket is issued (step S108). At the end of the process, the ticket data is stored in the portable storage medium, that is, the USB memory 60 (step S110).

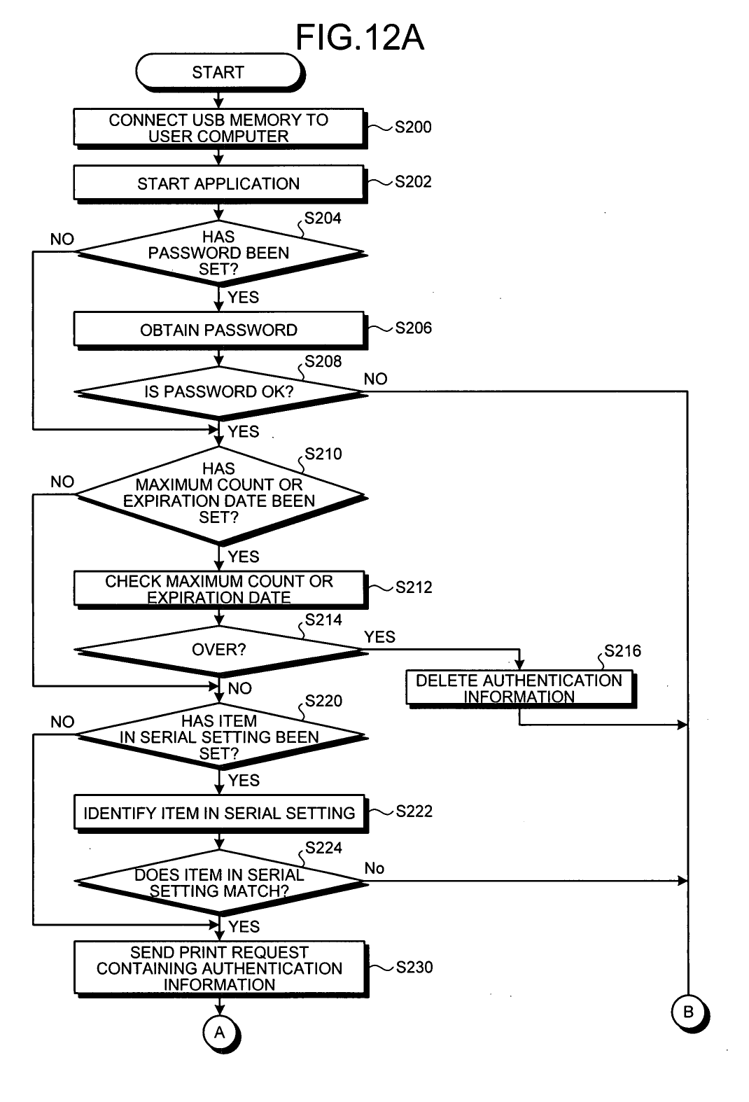

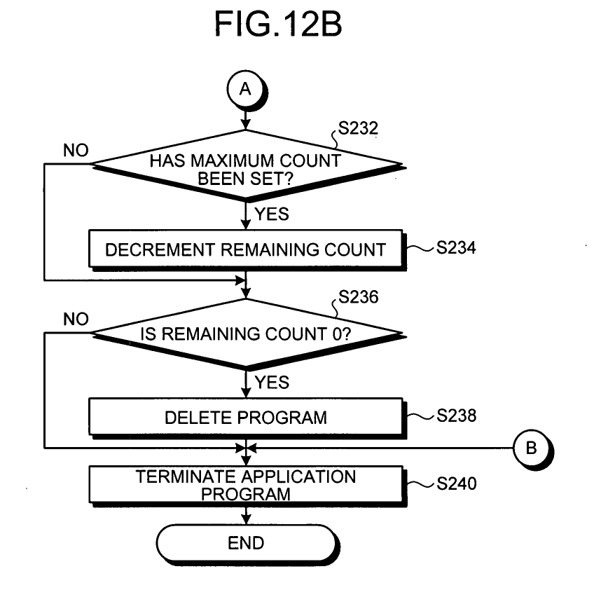

FIGS. 12A and 12B are a flowchart of a process to execute an application program stored in the USB memory 60 by the image forming apparatus 1. A flow is explained until a file on the user computer is printed out from the image forming apparatus in response to a print request issued based on an application program.

The USB memory 60 is first connected to the user computer (step S200). For example, in Windows® OS, an application program can be viewed as one execution file. The user runs the corresponding execution file.

The USB memory 60 connected to the user computer stores therein the application program containing, as shown in FIG. 3, the authentication information and the condition data. Therefore, with this USB memory 60 being connected to the PC, the application program, the authentication information, and the condition data corresponding to the desired function (in the example, printing) can be obtained.

This application program performs activation with the device that issues the authentication information when the application program is executed on the user computer for the first time. The condition data in the application program includes a ticket issuing time. If a predetermined period has passed since the ticket issuing time, the authentication information is deleted.

When the USB memory is connected to the user computer (step S200), the application program is executed (step S202). It is determined whether a password is set. If a password is set (Yes at step S204), the user computer inquires the password of the user. Then, the password is obtained from the user (step S206). It is determined whether the password is correct. If the password is incorrect (No at step S208), the process control goes to end (step S240). The authentication information can be deleted if erroneous passwords are entered over predetermined times.

If the password is correct (Yes at step S208), it is determined whether a maximum count or an expiration date is set. If a maximum count or an expiration date is set (Yes at step S210), the user computer checks the maximum count or the expiration date (step S212). Specifically, the information about the maximum count or the expiration date is contained in the application program in an encrypted form. With reference to such information, it is determined whether the authentication information is over the maximum count or the expiration date.

For encryption, a different key can be used each time of generating a ticket. If the user is identified through IC card authentication, an encryption key for the user can be obtained from an address book stored in the user computer or in a server employing a public key encryption scheme or the like.

If the authentication information is over maximum count or the expiration date (Yes at step S214), the application program causes the authentication information to be deleted (step S216), and the process control goes to end (step S240). After the authentication information is deleted in consideration of usability, it is preferable to notify to the user that the authentication information has been deleted.

Security can be improved by deleting the authentication information. It is possible to set some functions to be performed without authentication information. For example, if the viewing function is set to be performed without the authentication information, a user can use the viewing function after the authentication information is deleted.

Instead of deleting the authentication information, the application program can be deleted. Alternatively, both of the authentication information and the application can be deleted.

If the authentication information is over the maximum count or the expiration date (No at step S214), it is determined whether the serial setting is set. If the serial setting is set (Yes at step S220), the set item in serial setting is identified (step S222). If the corresponding item in the image forming apparatus matches with the item in serial setting (YES at step S224), a print request including the authentication information is sent to the image forming apparatus, and the image forming apparatus prints the file (step S230). Specifically, the image forming apparatus authenticates the request based on the authentication information, and when the request is authentic, prints the file.

If there is no image forming apparatus that allow printing, notice that printing has failed is displayed, for example, on a display screen. If the image forming apparatus does not match with the serial setting (No at step S224), the control process goes to step S240. The image forming apparatus has a right to determine whether the file is to be printed based on the authentication information attached to the request.

Activation, password, and maximum count or expiration period can be checked not in particular order, and any one can be checked first. The range of accessible image forming apparatuses can be identified from the serial setting and the model name and MAC address collected by using simple network management protocol (SNMP). Alternatively, activation can be performed only to an IP address in serial setting.

After completion of printing, if the maximum count is set (Yes at step S232), because the authentication information has been used, the remaining count is decremented (step S234). Finally, the remaining count is checked, and if the remaining count is 0 (Yes at step S236), the application program is deleted (step S238), and the control process goes to end (step S240).

Instead of deleting the application program, the authentication information can be deleted. Alternatively, both of the application program and the authentication information can be deleted.

The process of printing a file from the user computer in the image forming apparatus has been explained. Other processes such as a process for transmitting facsimile and a process for obtaining and setting device information of a target device are performed as the similar manner.

Furthermore, the application program can be an additional component for a printer driver, a plug-in for a web browser, a Java® script.

As explained above, an individual computer can obtain the application program by using a generally accessible device such as a USB memory instead of using an authentication device such as an IC card reader. Moreover, by containing the authentication information and the condition data in the application program, unauthorized ticket usage unexpected by the ticket issuer can be restricted. Still moreover, because the application program is stored in a portable recording medium, it is much easier to access the authentication information in the application program.

Also, by setting the maximum count of the authentication information, the possibility of danger of unauthorized use of the authentication information can be reduced. Also, this possibility can also be reduced by setting the expiration date of the authentication information. Furthermore, this possibility can also be reduced by specifying target devices that can use the authentication information. Still further, this possibility can also be reduced by checking a password before the application program is executed.

That is, with a scheme of using the authentication information being restricted by the application, unauthorized use of the authentication information can be prevented. Also, with target devices having various functions being restricted, it is possible to prevent unauthorized use of the authentication information, manage items that have conventionally been difficult to manage, such as the expiration date and maximum count, through access via the application program stored in a portable storage medium, and also prevent unauthorized use when the portable storage medium is stolen or lost.

According to an embodiment of the invention, the authentication information is used only for the application program, thereby restricting unauthorized usage.

Moreover, the condition data is helpful in restricting unauthorized usage

Furthermore, unauthorized usage by using a non-expected target device can be restricted.

Moreover, by using the authentication information only for printing operation, unauthorized usage of the authentication information can be restricted.

Furthermore, by using the authentication information only for facsimile operation, unauthorized usage of the authentication information can be restricted.

Moreover, by using the authentication information only for obtaining information or setting parameters, unauthorized usage of the authentication information can be restricted.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a storage unit that stores therein at least one application program that is used for generating a request for a predetermined process to a target device having a corresponding function;
a first receiving unit that receives various information including a desired application program among the application programs, condition data for using the desired application program, and user data that is information about an authentic user;
an authority-data generating unit that generates authority data including the desired application program, the condition data, and the user data, in a corresponding manner;
a recording unit that records the authority data on a portable recording medium;
a second receiving unit that receives, from outside, a request for the predetermined process that is generated based on the desired application program contained in the authority data recorded on the recording unit; and
a processing unit that performs the predetermined process in response to received request.

2. The information processing apparatus according to claim 1, wherein the condition data is required for a first authentication process performed before the application program contained in the authority data recorded on the recording unit is executed.

3. The information processing apparatus according to claim 2, wherein the condition data includes any one of a password that is used for the first authentication process and a maximum processing number of times and an expiration date that can be used for a second authentication process that is performed when the target device receives the request.

4. The information processing apparatus according to claim 1, wherein the condition data includes data for specifying the target device that is to perform the predetermined process in response to the request.

5. The information processing apparatus according to claim 4, wherein the condition data includes data that can identify any one of a media access control address, a network address, a serial number, and a model name of the target device.

6. The information processing apparatus according to claim 1, wherein the desired application program corresponds to a printing function, and the desired application program contained in the authority data recorded on the recording unit is used for transmitting a print request, data to be printed, and the user data that is used for an authentication process that is performed when target device having a printing function receives the print request.

7. The information processing apparatus according to claim 1, wherein the desired application program corresponds to a facsimile function, and the desired application program contained in the authority data recorded on the recording unit is used for transmitting a facsimile transmission request, data to be transmitted, and the user data that is used for an authentication process that is performed when target device having a facsimile function receives the facsimile transmission request.

8. The information processing apparatus according to claim 1, wherein the desired application program corresponds to a property setting function for checking and setting parameters of the target device, and the desired application program contained in the authority data recorded on the recording unit is used for transmitting a property setting request and the user data that is used for an authentication process that is performed when target device having a property setting function receives the property setting request.

9. A method of processing information comprising:
receiving an instruction of specifying a desired application program that is selected among application programs stored in a storage unit that are used for generating a request for a predetermined process to a target device having a corresponding function;
receiving an instruction of setting conditions for using the desired application program;
receiving user data that is information about an authentic user;
generating an authority data that includes the desired application program, data for the conditions, and the user data in a corresponding manner;
an authority-data generating unit that generates authority data including the desired application program, the condition data, and the user data, in a corresponding manner;
recording the authority data on a portable recording medium;
receiving, from outside, a request for the predetermined process that is generated based on the desired application program contained in the authority data recorded on the recording unit; and
processing the predetermined process in response to received request.

10. A computer program product that causes a computer to implement a method of processing information, the computer program product causing the computer to execute the method according to claim 9.

11. A method of processing information comprising:
receiving authority data including a desired application program that is used for generating a request for a predetermined process to a target device having a corresponding function, condition data for using the desired application program, and user data that is information about an authentic user, in a corresponding manner;
determining based on the condition data whether the desired application program is to be executed; and
executing, when the desired application program is determined to be executed at the determining, the desired application program whereby the request for the predetermined process is sent to the target device.

12. A computer program product that causes a computer to implement a method of processing information, the computer program product causing the computer to execute the method according to claim 11.
